(19) United States
(12) Patent Application Publication
(10) Pub. No.: US 2015/0102692 A1
(43) Pub. Date: Apr. 16, 2015

(54) TERMINAL ASSEMBLY FOR STARTER MOTOR OF VEHICLE

(71) Applicants: KYUNGSHIN INDUSTRIAL CO., LTD., Incheon (KR); Hyundai Motor Company, Seoul (KR)

(72) Inventors: Seung Deuk BAE, Jeonju-si (KR); Je Hyuk YEON, Incheon (KR)

(73) Assignees: KYUNGSHIN INDUSTRIAL CO., LTD., Incheon (KR); HYUNDAI MOTOR COMPANY, Seoul (KR)

(21) Appl. No.: 14/143,980

(22) Filed: Dec. 30, 2013

(30) Foreign Application Priority Data
Oct. 10, 2013 (KR) 10-2013-0120260

(51) Int. Cl. H02K 11/00

(52) U.S. Cl. CPC H02K 11/00
USPC 310/71

(57) ABSTRACT

A terminal assembly coupled to a starter motor terminal mounted to a vehicle includes a first terminal having a terminal engaging part engaged with a terminal of a starter motor, and a first terminal coupling part extending from one side of the terminal engaging part. A second terminal is detachably engaged with the first terminal coupling part.

### CROSS-REFERENCE TO RELATED APPLICATION

This application claims under 35 U.S.C. §119(a) the benefit of priority to Korean Patent Application No. 10-2013-0120260 filed Oct. 10, 2013, the entire contents of which are incorporated herein by reference.

### TECHNICAL FIELD

The present disclosure relates to a terminal assembly for a starter motor of a vehicle for improving a loosening problem of an alternator terminal and a battery terminal simultaneously engaged with a terminal of the starter motor.

### BACKGROUND

A motor vehicle powered by a combustion engine is generally provided with an electrically powered starter motor for starting the combustion engine. The starter motor receives the electric power from a battery mounted to the vehicle to rotate a combustion engine's crankshaft and start the engine.

The starter motor is connected to a battery, and the battery receives the electric power from an alternator that generates AC power by receiving rotating power of the engine through a drive belt.

In the case of currently mass-produced bus, as shown in FIG. 1, an alternator cable terminal 2 and a battery cable terminal 3 are engaged with a terminal of a starter motor 1 through a bolt and a nut. That is, the two terminals (the alternator cable terminal and the battery cable terminal) are simultaneously engaged with one terminal of a start motor according to the related art.

Here, when two terminals are simultaneously engaged with one terminal provided in a starter motor, vibrations of the vehicle may loosen the structure. Further, heat emission due to the loosened structure may cause a fire.

### SUMMARY

The present disclosure has been made in an effort to solve the above-described problems associated with prior art. The present disclosure provides a starter motor terminal assembly of a vehicle that can improve a loosened assembly of a terminal by engaging one of a battery terminal and an alternator terminal with a terminal provided in a starter motor and engaging the other terminal with a terminal directly engaged with the starter motor.

In accordance with an exemplary embodiment of the present disclosure, a terminal assembly coupled to a starter motor terminal mounted to a vehicle is provided. The terminal assembly includes a first terminal having a terminal engaging part engaged with the starter motor terminal, and a first terminal coupling part extending from one side of the terminal engaging part. A second terminal is detachably engaged with the first terminal coupling part.

The first terminal coupling part includes a space in which pressing flanges protruding from the left and right sides of the space, and a terminal engaging member assembled in the space is fixedly supported by the pressing flanges folded toward the space.

The terminal engaging member includes a support inserted into the space of the first terminal coupling part, and the terminal engaging part protruding to pass through the first terminal coupling part. The support is formed of a polygonal plate shape to prevent from rotating thereof in the space.

The second terminal includes a second terminal coupling part coupled to the first terminal coupling part, the second terminal coupling part includes fixed flanges protruding to the left and right sides, and the fixed flanges are folded toward the first terminal coupling part when the second terminal coupling part is coupled to the first terminal coupling part, preventing the second terminal from rotating after coupling thereof.

One of the first terminal and the second terminal is used as a battery cable terminal, and the other terminal is used as an alternator cable terminal.

According to the terminal assembly for a starter motor of a vehicle of the present disclosure, one of a battery terminal and an alternator terminal as a first terminal is engaged with and fixed to a start motor terminal. The other terminal as a second terminal is engaged with the first terminal to prevent loosening of the terminals which are directly engaged with the start motor terminal. Further, the first terminal can be easily separated while the second terminal maintains being engaged with the starter motor.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure.

FIG. 1 is a view showing a terminal coupling structure engaged with a starter motor according to the related art.

FIGS. 2 and 3 are views showing a terminal assembly for a starter motor of a vehicle according to an embodiment of the present disclosure.

FIG. 4 is a view showing a state in which a terminal assembly according to an embodiment of the present disclosure is coupled to a terminal of a starter motor.

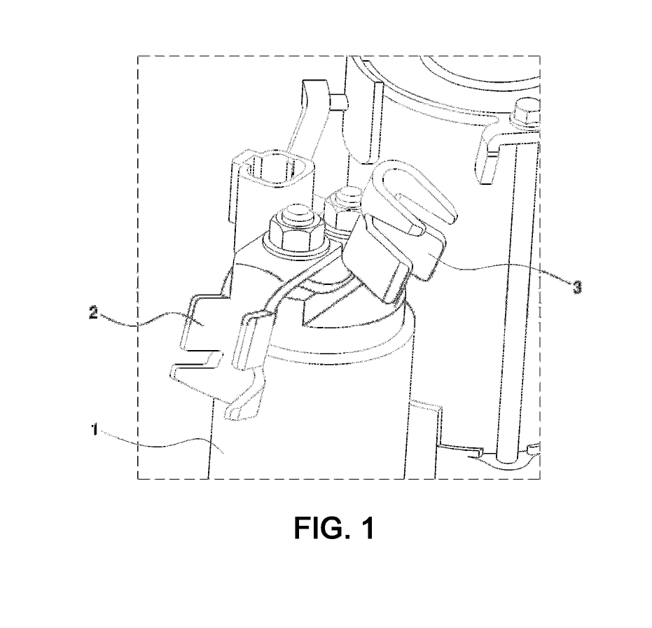

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, an exemplary embodiment of the present disclosure will be described with reference to the accompanying drawings so that those skilled in the art to which the present disclosure pertains can easily carry out the disclosure.

The present disclosure relates to a terminal assembly engaged with a starter motor terminal mounted to a vehicle. Only one terminal as a first terminal of a battery terminal and an alternator terminal is mounted to the starter motor terminal, and the other terminal as a second terminal is coupled to the first terminal.

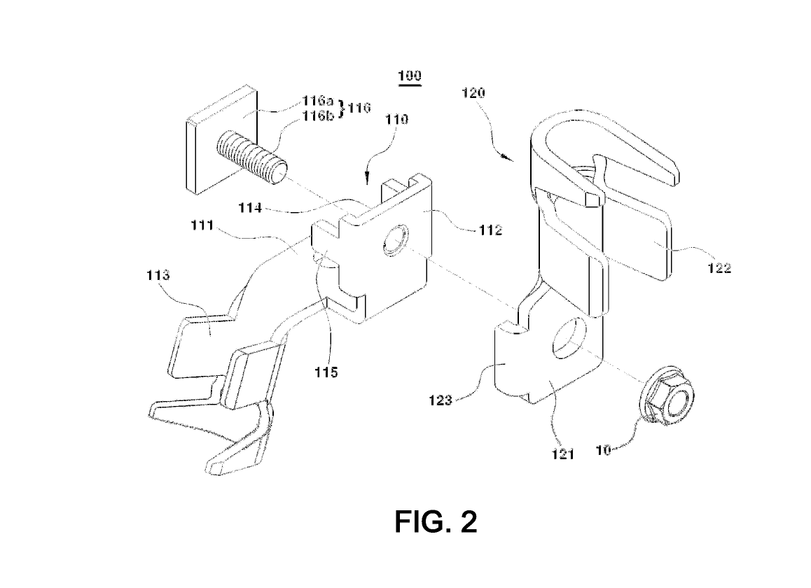

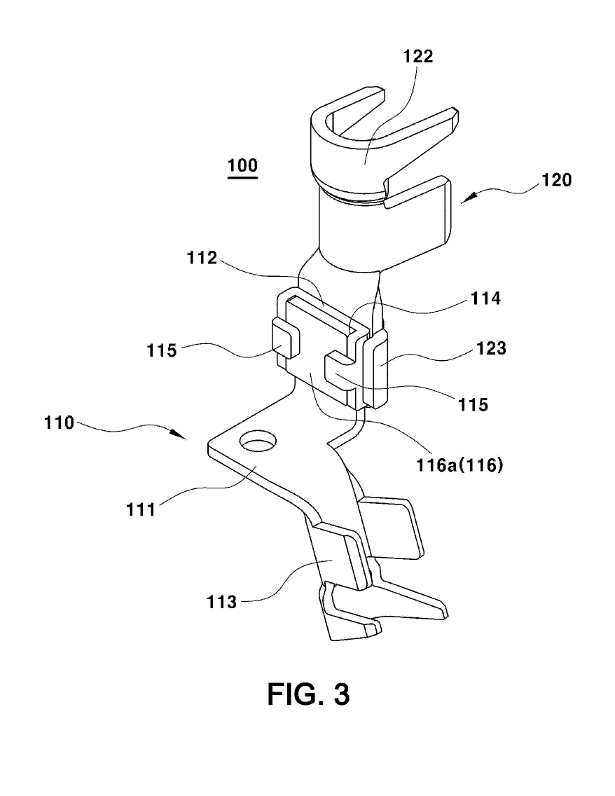

As shown in FIGS. 2 and 3, a terminal assembly 100 for a starter motor according to an embodiment of the present disclosure includes a first terminal 110 directly engaged with a starter motor terminal, and a second terminal 120 detachably engaged with the first terminal 110.

The first terminal 110 includes a terminal engaging part 111 engaged with the starter motor terminal, a first terminal coupling part 112 extending to one side of the terminal engaging part 111, and a first cable coupling part 113 extending to the other side of the terminal engaging part 111. The first cable coupling part 113 and the first terminal coupling part 112 are bent at an angle with respect to the terminal engaging part 111 and/or in a predetermined shape.

The first terminal coupling part 112 includes a space 114 having a predetermined depth, and pressing flanges 115 protruding to the left and right sides of the space 114. The pressing flanges 115 are folded toward the space 114 to fixedly support a terminal engaging member 116 mounted to the space 114 such that the terminal engaging part 116 cannot be separated.

The terminal engaging member 116 includes a plate-shaped support pat 116a inserted into the space 114 when mounting to the first terminal coupling part 112, and an engaging part 116b protruding to pass through the first terminal coupling part 112. The support part 116a may have a polygonal plate shape to prevent from rotating in the space 114, and the engaging part 116b may have a stud bolt shape having a spiral structure coupled to an engaging member 10 such as a nut.

The second terminal 120 includes a second terminal coupling part 121 detachably engaged with the first terminal coupling part 112, and a second cable coupling part 122 extending to one side of the second terminal coupling part 121. The second terminal coupling part 121 includes fixed flanges 123 protruding to the left and right sides of the second terminal coupling part 121.

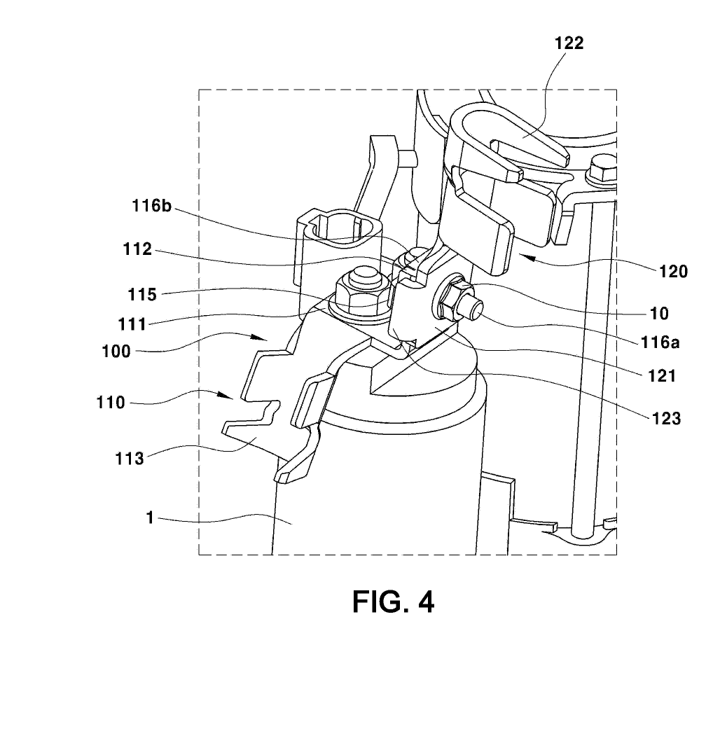

As shown in FIGS. 3 and 4, the fixed flanges 123 are folded toward the first terminal coupling part 112 when the second terminal coupling part 121 is coupled to the first terminal coupling part 112 by the engaging member 10, preventing the second terminal 120 from rotating.

When there is a cable problem or the like, as the second terminal coupling part 121 is coupled to the first terminal coupling part 112 through the engagement member 10, the second terminal 120 can easily separate the second terminal 120 from the first terminal 110.

Here, one of the first terminal 110 and the second terminal 120 may be used as a battery cable terminal, and the other terminal may be used as an alternator cable terminal. Thus, a battery cable may be connected to one of the first cable coupling part 113 and the second cable coupling part 122, and an alternator cable may be connected to the other cable coupling part.

The terminal assembly for a starter motor of a vehicle can prevent a terminal coupled to a starter motor terminal from loosening, and accordingly can prevent problems such as vehicle fires, an engine start error, a battery charging error caused by heat emission generated when the terminal is released, etc.

Further, when a coupling assembly of a battery cable is related to an engine start and an alternator cable is related to a battery charging to the terminal assembly for a starter motor of the present disclosure, an assembly process can be completed by engaging only one terminal to the starter motor terminal in an assembly line. Further, an operation time is shortened and an operation process becomes simple, thereby improving productivity.

Although the exemplary embodiment of the present disclosure has been described in detail, the scope of the present disclosure is not limited to the embodiment and various modifications and improvements of the basic concept of the present disclosure defined in the claims, which are made by those skilled in the part to which the present disclosure pertains, fall within the scope of the present disclosure.

What is claimed is:

1. A terminal assembly coupled to a starter motor terminal mounted to a vehicle, the terminal assembly comprising:
a first terminal having a terminal engaging part engaged with the starter motor terminal;
a first terminal coupling part extending from one side of the terminal engaging part; and
a second terminal detachably engaged with the first terminal coupling part.

2. The terminal assembly of claim 1, wherein the first terminal coupling part comprises a space, pressing flanges protruding from the left and right sides of the space, and a terminal engaging member assembled in the space is fixedly supported by the pressing flanges folded toward the space.

3. The terminal assembly of claim 2, wherein the terminal engaging member comprises a support inserted into the space of the first terminal coupling part, and an engaging part protruding to pass through the first terminal coupling part, wherein the support is formed of a polygonal plate shape to prevent from rotating thereof in the space.

4. The terminal assembly of claim 1, wherein the second terminal comprises a second terminal coupling part coupled to the first terminal coupling part, the second terminal coupling part comprises fixed flanges protruding to the left and right sides, and the fixed flanges are folded toward the first terminal coupling part when the second terminal coupling part is coupled to the first terminal coupling part, preventing the second terminal from rotating after coupling thereof.

5. The terminal assembly of claim 1, wherein one of the first terminal and the second terminal is used as a battery cable terminal and the other terminal is used as an alternator cable terminal.
